(19) United States
(12) Patent Application Publication
(10) Pub. No.: US 2004/0109053 A1
(43) Pub. Date: Jun. 10, 2004

(54) Print medium assembly and method of producing a printed sign assembly

(76) Inventor: Gustav Allen Ray, Pacifica, CA (US)

Correspondence Address: Gustav Allen Ray, 48 Desvio Court, Pacifica, CA, 94044, US

(21) Appl. No.: 10/314,317

(22) Filed: Dec. 9, 2002

(51) Int. Cl. B41J 2/01

(52) U.S. Cl. 347/101

(57) ABSTRACT

Using a personal desktop printer to print on a print medium for providing a print medium assembly, assembled from individual printed print mediums to create the appearance of a single large printed print medium.

### BACKGROUND OF THE INVENTION

Laser printers and ink jet printers have spawned a wide variety of options for personal printing that have not existed previously. A personal computer user can now prepare text and images on a word processing program and print the text and images directly onto print mediums that pass through the laser or ink jet printer. Such print mediums may consist of labels applied to a backing print medium, or may be made of card stock for cutting into business cards. The print mediums are typically 8 and ½ inches by 11 inches in dimension and are fed into the laser or ink jet printer through a standard paper tray.

This invention relates to providing a finished printed product that is assembled from several printed print mediums. It also concerns methods of printing image sections of a larger image up to one or more edges of the printed print mediums by feeding them through standard laser printers, ink jet printers, dot matrix printers, photocopiers or other common printing apparatus.

Conventional desktop personal printers have several limitations of particular relevance to the present invention, namely, conventional desktop personal printers do not print completely to the edge of the print medium. In particular, most ink jets, all dot matrix, all laser printers and the like, are not able to print to any edge of any printable media. These printers typically require at least one half inch of unprinted edge in order to grip the leading edge and trailing edge of the paper. Further, they do not print completely to the sides adjacent to the leading and trailing edges. Typically these printers print to within one quarter of an inch to the side of the page. In addition, the majority of many standard laser printers, inkjet printers or photocopiers will only accept rectangular print mediums of widths not exceeding 8 and ½ inches. Accordingly, there has been a need for the assembly of small individual print mediums printed on a conventional desktop printer to form a single larger print medium assembly.

In order to use a conventional desktop printer and a personal computer system to construct a print medium assembly assembled from a plurality of individual printouts with images printed to at least one edge of a printed print medium, with a quality comparable to that of a professional printing company, the user would need to use scissors, some other manual cutting device or would need to take the printed paper to a professional printing company for trimming of the unprintable edges on the professional printing company's equipment. Uniformity and accuracy of the cuts to remove the unprinted edges are required in order to assemble the printed print mediums with the desired quality, shape and consistency. Further, this procedure is difficult, tedious, and hard to reproduce consistently due to the time and accuracy it takes to cut the printed print mediums.

From the foregoing, there is the need to enable a user of a desktop printer in a personal computer system to print images larger than 8.5 by 11 inches which have the appearance of being professionally produced as a single large print medium in that the final product has printed images which extended beyond a single printed print medium. This is accomplished by printing up to one or more die cuts of the product and with all copies of the final product uniform in size and consistent in quality and accuracy. When enabled, this allows for assembling the individual prints into one print medium assembly which gives the appearance of a single large printout. This creates a further need to have a system for marking and organizing the individual printouts correctly for assembly into the larger print medium assembly.

The foregoing limitations of personal desktop printers are important, at least where a high quality print medium assemblies assembled from a plurality of printed print mediums are desired, which is usually the case when one wants to make signs, banners, and other large images by assembling smaller print mediums with partial images into one large complete image.

### SUMMARY OF THE INVENTION

Directed to remedying the problems in and limitations of the prior art, and meets the foregoing needs, disclosed herein are improved methods for creating signs (and the like) easily, quickly and economically providing a high quality finished printed product that has the appearance of a single large image achieved through printing several print mediums by a conventional desktop printer for assembly into a larger print medium assembly.

The method of the present invention is one for making a finished printed output having graphical content printed to a plurality of finished printed outputs for assembly into a larger print medium assembly. The method comprises loading a plurality of print mediums into a printer connected to a personal computer system. The print medium is loaded so the print medium is in a print position. The print medium has a die cut line defining outwardly therefrom a continuous outer margin along the entire periphery of the print medium and defining inwardly therefrom a primary printable area on the print medium. The method also comprises printing (in either the landscape or portrait direction), with the printer in the personal computer system, a section of the graphical image on a plurality of print mediums such that at least a portion of the graphical image sections are printed up to the die cut line defining the primary printable area of the the print medium.

The personal computer system of the present invention includes an input means for providing input to the personal computer system, a central processing unit, a memory connected to the central processing unit, an operating system program stored in the memory, a display responsive to control by the central processing unit, and a printer responsive to control by the central processing unit. The present invention comprises the following improvement to such a personal computer system. A plurality of substrates for printing on a personal printer having a continuous die cut line inward of the outer periphery such that the die cut line defines a primary printable area on the substrate inwardly of the die cut line. Further, the improvement comprises a software program compatible with the operating system loaded into the memory. The software program includes a method for providing an output having a plurality of sections of the larger image printed to a plurality of individual print mediums such that at least one portion of the image is printed up to one side of the die cut line on one of the print mediums. The software program further includes methods used to assign indicia on the individual print mediums for aiding in assembling the print mediums in the proper order to form the print medium assembly.

Embodiments of the present invention extend to a method for printing on label print mediums and then assembling them into a larger label print medium. The method includes forming a label print medium of approximately 8 and ½ inches wide by approximately 11 inches long, with the label print medium being approximately 15 mils or less thick. A die cut line is formed around the periphery of the label print medium to divide the print medium into at least two sections. An individual printable area is formed by a closed die cut pattern. Information is printed on a printable area by feeding the print medium through a printer. The printed area is then removed from the print medium for assembly in juxtaposition to each other to form the larger print medium assembly. The facestock of the label may be formed of any color polyester, Tyvek, paper, substantially transparent paper or transparent film so that the color and/or texture of a substrate may be viewed through the transparent paper facestock or film facestock. Adhesive in the label print medium which is stable up to at least 200 degrees Celsius for at least 0.1 seconds may be used to prevent the adhesive in the label print medium from oozing out of the label assembly in the high-heat environment of a laser or xerographic printer. The backing of the label print medium may contain a release coating. Further, a cohesive adhesive may be used so the printed label only sticks to a substrate with the corresponding cohesive adhesive.

The substrate that the labels are applied may be formed of any color vinyl, polyester, polypropylene, paper, or fabric. One such substrate is a 15 mil thick white vinyl banner with the dimensions of 3 feet by 6 feet. The substrate may also contain grommets at the corners for fastening the substrate to another object for display.

Embodiments of the present invention may be formed with limitations on the width of the print mediums, such as 8.5 inches wide. Such width limitations are intended to insure that the present print medium assemblies are sufficiently narrow to pass through current laser printers, ink jet printers, and photocopiers. Common printers and copiers may have a thickness restriction as well as a width restriction, due to interior clearances and due to the radii of bends in the print medium path through those machines.

Embodiments of the present invention extend to a method for printing on 8.5 inch wide by 6 feet long banner paper designed to be printed on by a desktop printer. The method includes forming a continuous banner paper roll with microperfs approximately one half inch from the edges. A large image is divided up into a plurality of sections for printing on the 8.5 inch wide banner paper. The image sections are then printed up to a portion of one or more of the microperfed lines by feeding the print medium through the printer for printing on the banner paper. Individual printed banner containing sections of the larger image are removed from the printer and the microperfed printed sections are removed for assembly in juxtaposition to each other to form the larger image by assembling the print medium assembly.

Embodiments of the present invention extend to a method for printing on a plurality of 8 and ½ inch by 11 inch printable print mediums containing specific die cut shapes defining a primary printable area of the print mediums for later assembly into a specific print medium assembly shape and size. The individual print medium die cut shapes can define numerous specific print medium assembly shapes such as a triangle, circle, semi-circle or octahedron.

Other objects, features, and advantages of the invention will become apparent from a consideration of the following detailed description and the accompanying figures.

### BRIEF DESCRIPTION OF THE DRAWINGS

FIG. 1 is a block diagram of an improved personal computer system of the present invention.

FIG. 2 is a front elavational view of a label print medium of a preferred embodiment of a print medium of the present invention.

FIG. 3 shows a portion of a graphical image for printing on the label shown in FIG. 2.

FIG. 4 is the same view as shown in FIG. 2, after printing a portion of the graphical image shown in FIG. 3 using a desktop printer or copier.

FIG. 5 shows portions of the image in FIG. 3 printed using a desktop printer of copier on labels as shown in FIG. 2.

FIG. 6. shows the printed portions removed from the label print mediums shown in FIG. 5 and assembled into the print medium assembly.

FIG. 7 is a front elavational view of a label print medium with a die cut pattern defining a primary printable area for later assembly into a triangle banner.

FIG. 8 is a front elavational view of a label print medium with a die cut pattern defining two primary printable areas for later assembly into a triangle banner.

FIG. 9 is a front elavational view of a label print medium with a die cut pattern defining two primary printable areas for later assembly into a triangle banner.

FIG. 10 shows a portion of a larger graphical image for printing on the label print medium of FIG. 7.

FIG. 11 shows the graphical image portion of FIG. 10 printed using a conventional printer or copier on the primary print portion shown in FIG. 7.

FIG. 12 shows the primary printed portions of FIGS. 6-8 printed on with a conventional printer or copier then removed and assembled into a larger print assembly.

FIG. 13 is a banner material with lines of weakening along two edges.

FIG. 14 is a portion of a larger image for printing on the banner in FIG. 13.

FIG. 15 shows sections of the image in FIG. 14 printed on banners as show in FIG. 13. using a conventional desktop printer.

FIG. 16 shows the printed sections of FIG. 15 assembled into a print assembly.

FIG. 17 is a front elavational view of a label print medium with two primary print areas.

FIG. 18 shows a portion of a larger graphical image for printing on the label print medium of FIG. 17.

FIG. 19 shows portions of FIG. 18 printed on the primary print areas of two label print mediums as shown in FIG. 17.

FIG. 20 shows the printed portions of FIG. 19 removed and assembled into a print assembly.

### DETAILED DESCRIPTION OF PREFERRED EMBODIMENTS

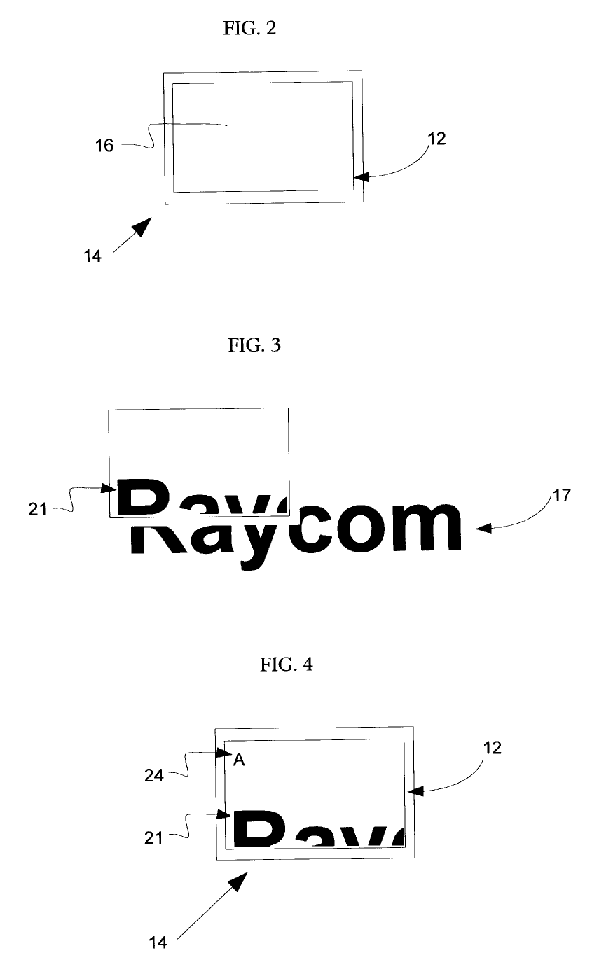

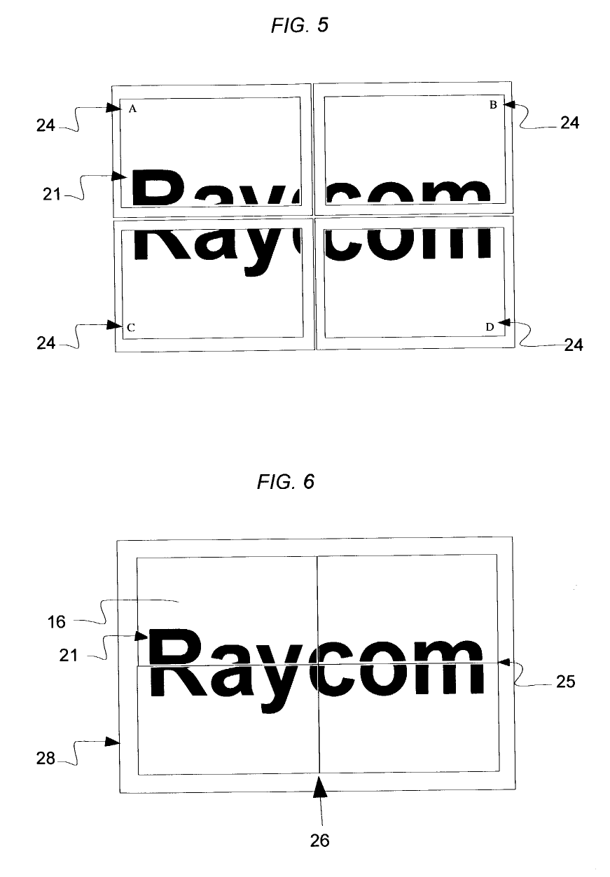

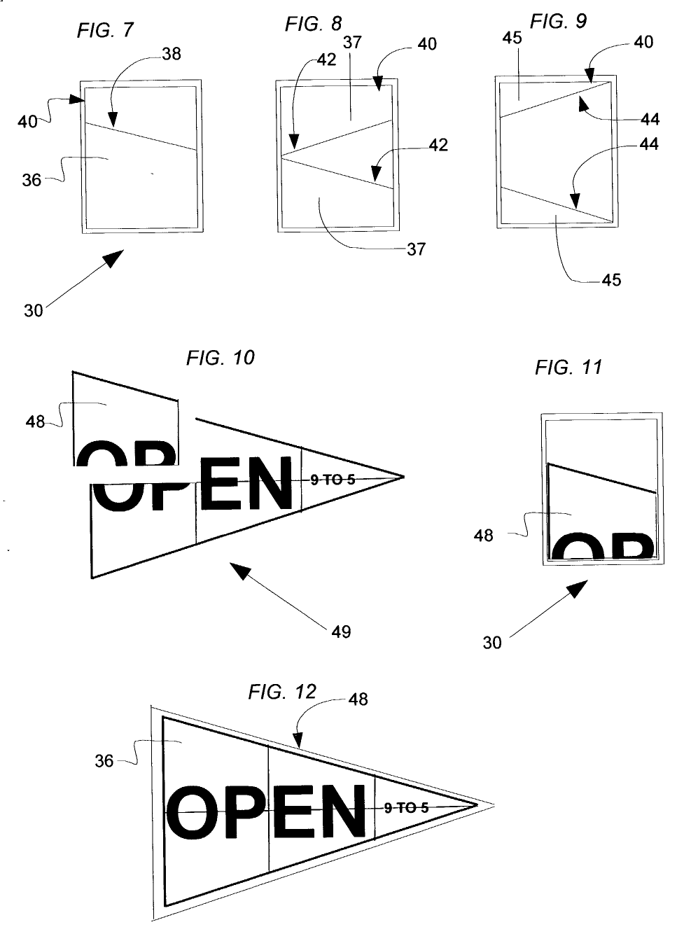

Referring to the drawings, a number of embodiments of the present invention are illustrated. A first preferred embodiment is shown in FIGS. 2-6, and this embodiment or print medium assembly is shown generally in FIG. 6. The assembly includes a label print medium as shown in isolation in FIG. 2 and having a length of eleven inches and a width of eight and ½ inches. The label print medium can also be standard A4 label, which is 8.27 inches by 11.69 inches. The following materials and dimensions are provided for purposes of illustration but not of limitation. The print medium 15 is preferably made from a pressure sensitive label construction approximately 7 to 15 mil thick, such as that available from Fasson. The label construction is typically composed of a facestock for printing on, an adhesive layer and a release coated backing. A specific type of label print medium is a 8 and ½ inch by 11 inch print medium cut or slit from Fasson® CopyCode™ II White Polyester/S730/50# SCK. The material is sold from Fasson in a roll form and then converted into print mediums for feeding through desktop printers by cutting or slitting the roll into 8.5 by 11 inch print mediums and forming a line of weakness by die cutting the die cut line 12 through the facestock forming the primary printable area 16 of dimension 7 by 10 inches. The 8.5 inch by 11 inch print medium such as FIG. 2 is now of the correct dimensions for feeding into a desktop printer, printing on a primary print area and assembling into a print medium assembly.

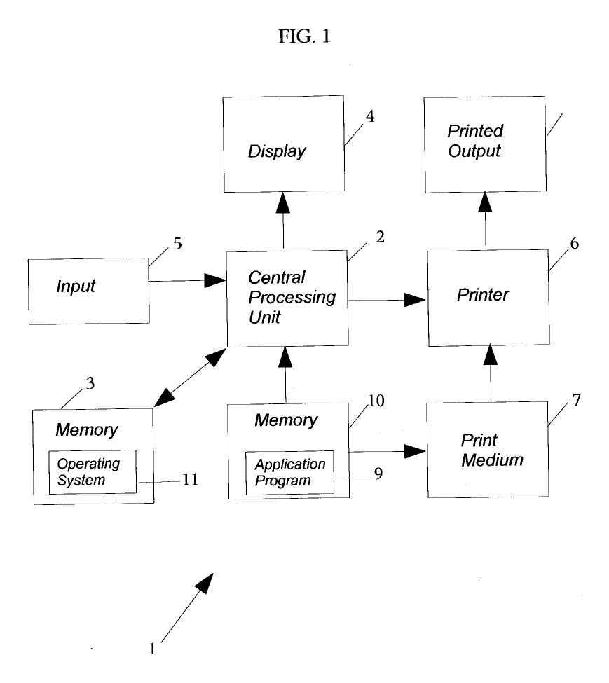

Referring to FIG. 1, a personal computer system 1 incorporating the present invention is shown. The personal computer system 1 includes a central processing unit 2 and a memory 10 connected to the central processing unit 2. The central processing unit 2 and the memory 10 are of conventional types known in the art as parts of a conventional personal computer system. Non-limiting personal computer examples include Compaq, Toshiba Tecra, and Dell. The memory 10 typically includes both read only memory and random access memory. The memory 10 can be in one or more forms, such as integrated circuit, flash memory, magnetic storage device, or optical storage device.

The personal computer system 1 also includes a display 4 that responds to control by the central processing unit 2 of a conventional type. Specific non-limiting examples include cathode ray tube, liquid crystal display or any type of display suitable for use with any of the aforementioned specific examples of personal computer systems.

Another conventional element of the personal computer system 1 is input means 5 for providing input to the personal computer system 1. Non-limiting examples of the input means 5 include a microphone, keyboard and/or a mouse.

Another conventional component of the personal computer system 1 is a printer 6 which responds to control by the central processing unit. The printer 6 is particularly a desktop printer and preferably one of the following types: ink jet, laser, solid ink jet, thermal ink, or dot matrix.

An improvement to the aforementioned computer system 1 provided by the present invention includes a print medium 7 to be loaded into the printer 6 for printing therethrough to provide a printed output 22. Details of the print medium 7 will be described below.

Another improvement added by the present invention to the personal computer system 1 is an application program 9. The program 9 can be loaded or made accessible via a memory device 10 of the present invention described below. Alternatively, the application program 9 can be loaded in the main memory 3 or it can be provided as apparatus made available by whatever suitable means (e.g., by interactive communication or download from another source, such as the Internet or other connected network or device). In any event, the application program 9 is compatible with an operating system 11 loaded in the memory 3. Non-limiting examples of such an operating system 11 include an operating system used in Macintosh computers or an operating system used in IBM-compatible personal computers (e.g. Unix, Linux, Windows 95, Microsoft Windows NT, or Macintosh OS 8.0). In whatever operating system-compatible form the application program 9 takes, the program includes a method used in determining what and how to print with regard to the present invention. The program also divides up the larger image into appropriate sized sections for printing on a desktop printer such that upon printing sections of the image print up to the die cut line 12. FIG. 3 shows how the program would begin to divide up a larger image 17 into sections 21 for printing. FIG. 4 shows how the program divided up the larger image 17 into four sections with each section having a portion of the image printed up the the die cut line 12 for later assembly in juxtaposition to each other. The program 9 can also include methods used for orienting (e.g. landscape or portrait), portioning, sizing and positioning what is to be printed. Printing can include images, text, indicia and the like. The program 9 further includes methods used to assign indicia on the individual print mediums for aiding in later assembly into the print medium assembly shown in FIG. 5. These methods of which the application program 9 is comprised and the memory device 3 will be further described below.

A specific typical graphical application creating means program is Adobe Photoshop 5.0 available from Adobe. Non limiting additional examples of graphical image creating means are Microsoft Word, Corel Draw, and Staroffice. These programs communicate with the operating system program 11 to receive control information from user input into the personal computer system 1. The graphical image creating means then creates with the personal computer system 1 a graphical image to be printed onto principally the primary printable area of the substrate 16 of the print medium 14. The graphical image creating means can be used to create two or more partial images for printing on one or more of the print medium shown in FIG. 2. The graphical creating means can also be used to print partial images for printing on print mediums of medium shown in FIG. 2 such that when the printed portion 16 is removed and assembled in the correct position relative to the other printed medium it forms an image assembly shown in FIG. 6 assembled from the partial images.

Referring to FIGS. 2-6, the preferred embodiment print medium shown in FIG. 2 of the present invention comprises a label print medium 14 that can be loaded in the printer 6 of the personal computer system 1. The print medium 14 is preferably made from a pressure sensitive label construction approximately 7 to 15 mil thick, such as that available from Fasson. A specific type of label print medium is a 8 and ½ inch by 11 inch print medium cut or slit from Fasson® CopyCode™ II White Polyester/S730/50# SCK. The material is sold from Fasson in a roll form and then converted into print mediums for feeding through desktop printers by cutting or slitting the roll into 8 and ½ inch by 11 inch print mediums. The substrate in FIG. 2 has an outer periphery or edge of rectangular shape in the pictured embodiment. A continuous line of weakening is formed by the die cut line 12 which is spaced one inch inwardly of the outer periphery. The die cut line 12 in FIG. 2 is located such that it defines or circumscribes a primary printable area 16. The primary printable area 16 is located inwardly of the die cut line 12. The die cut line 12 can be made to define an outer boundary of the primary printable area of any desired shape. It gives a rectangular shape as shown in the drawings; however, other shapes can be defined such as a triangle or circle.

The primary printable area of the substrate 16 is located to receive printing of the image provided from the personal computer system 1 under control of the application program 9 and through the printer 6. More specifically, this area is defined such that at least a portion of the graphical image, indicia, or text is printed up to at least a portion of the die cut line 12 so that when the printed sections of the larger image are later assembled in juxtaposition to each other into a print medium assembly they appear as a single larger image as shown in FIG. 6. See for example, FIG. 4 wherein a section of the graphical image 21 is shown printed with at least one edge thereof continuously printed up to the die cut line 12. Said section of the graphical images being determined by the application program 9 in the computer system 1. Other sections of the image can be seen printed on label sheets as shown in FIG. 5 as determined by the application program in the computer system 1. The primary purpose of the application program in the computer system 1 being to divide a large image up into several smaller sections for printing on the primary printable portion 16 for later assembly into a print medium assembly as shown in FIG. 6.

FIGS. 4-5 show the print medium further comprises instructional indicia 24 disposed on the primary printing area 16. The instructional indicia 24 is particularly shown, but is not limited to, letters which are easily discerned by a user of the present invention. For example, in FIG. 4 the indicia 24 letter “A” identifies a “upper left” portion of the print medium assembly and an orientation.” The indicia 24 shown in FIG. 5 are the letters “A”, “B”, “C”, and “D” which identify the orientation and position of the sections of image for later assembly into the larger image assembly shown in FIG. 6. These particular indicia identify the orientation and position, but other types of instructional indicia can be used (for e.g., letters, arrows, or shapes or a combination thereof). Further, the indicia can be disposed on the secondary printing area of the print medium or the indicia can be disposed on the backing of the print medium. Further, a grid pattern with corresponding instructional indicia can be printed on the substrate in order to facilitate assembly of the banner in the correct manner.

FIG. 5 shows the sections of the larger image 17 after they have been printed and are ready for removal of the primary printed section 16 for assembly into a larger image.

FIG. 6 shows the primary printed sections of FIG. 5 removed and then adhered to the banner material 28. The lines 25 and 26 show how the sections of the larger image line up in juxtaposition with each other to form a single large image. The banner material is preferably made of white 15 mil thick vinyl so as to withstand exposure to water and outdoor use. However, other types and colors of materials can be used such as Tyvek, canvas, cotton, polyester and paper. Further, a grid of lines spaced to define a 7.5 inch by 10 inch grid may be preprinted on the banner material in order to aid in adhering the labels to the banner material in the correct orientation and space.

Another preferred embodiment of the print medium is show in FIGS. 7-12. This embodiment comprises a method for printing sections of a larger image, such as that shown in the image section 36, of a larger graphical image 49 on a plurality of 8 and ½ inch by 11 inch printable label print mediums with primary print sections 36, 37 and 45 shown in FIGS. 7-9. Said label sheets shown in FIGS. 7-9 containing specific lines of weakening made by forming die cut lines 38, 40, 42 and 44. Said die cut lines further defining primary printable areas 36, 37 and 45 of the print medium. FIG. 10 shows a larger image 49 and how a section of the image 36 is removed for printing on the print medium show in FIG. 7. FIG. 11 shows the image section 48 printed in the primary printable section 36 the print medium 30. FIG. 12 is an image assembly produced by printing sections of a larger image 49 on the print mediums shown in FIGS. 7-9 and then removing the primary printed sections for assembly in juxtaposition to each other to form a image assembly. The assembly forming the triangle image assembly as shown in FIG. 12. The individual print medium die cut shapes can further define but are not limited to numerous specific print medium assembly shapes such as a square, arrow, circle, semicircle or octahedron.

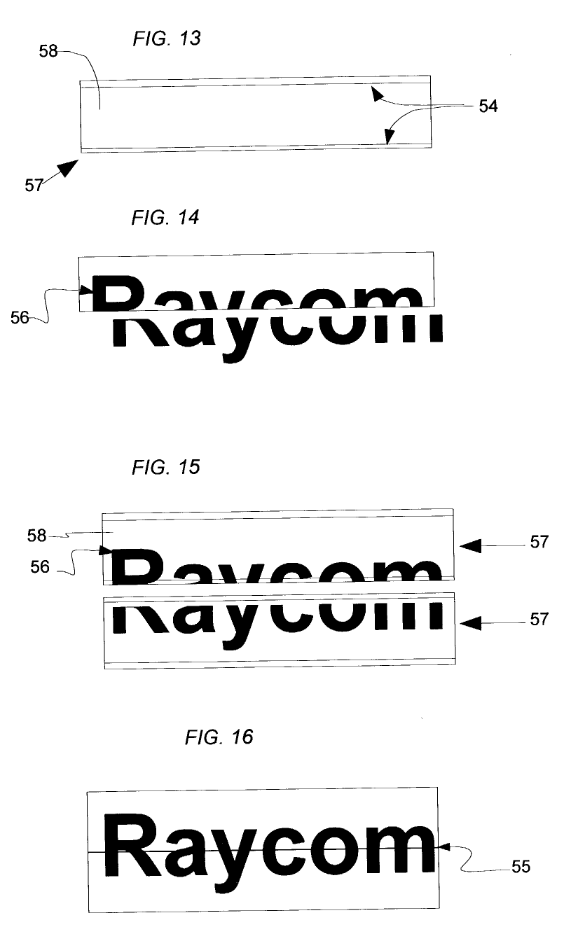

Another preferred embodiment (banner paper) of the print medium 57 is shown in FIGS. 13-16. A specific type of banner paper is available from Simpson Paper Mill in Pomona Calif. The banner paper is cut or slit to 8 and ½ inches wide by six feet in length. Two lines of weakening 54 are formed by microperforating segments which are located at ¾ inch inwardly from and parallel to the 8 and ½-inch long edges. The microperforation lines 54 can consist of cuts which vary in length from 0.0125 to 0.0135 inch and which are separated by ties that vary in length from 0.0045 to 0.0050 inch. Thus, there are between fifty-three and fifty-nine perforations per inch, with an average being fifty-six, or alternatively between thirty-five and fifty-nine perforations per inch. The embodiment of FIG. 13 contains a primary printable area 58 defined by the lines of weakening 54. FIG. 14 shows a section of a larger image ready to be printed on by a desktop printer. The image section 56 is printed in the primary printable portion 58. FIG. 15 shows how the computer system 1 has divided up the larger image into two sections and printed them on the banner paper 57. The primary printed sections 58 of the banner are then removed and placed in juxtaposition to each other as show in FIG. 16. Line 55 shows how the the smaller images line up to form a larger assembled image.

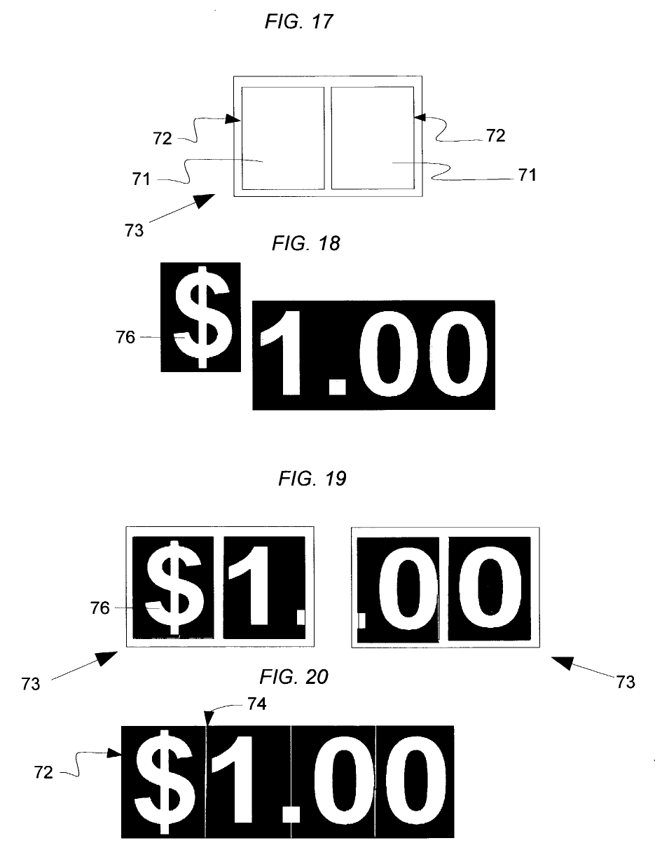

Another preferred embodiment is show in FIGS. 17-20. This embodiment comprises a pressure sensitive label assembly wherein there are two primary printable as shown in FIG. 17. The label print medium 73, as shown in isolation in FIG. 17 having a length of 11 inches and a width of 8.5 inches. The label print medium 73 can also be standard A4 label, which is 8.27 inches by 11.69 inches. The following materials and dimensions are provided for purposes of illustration but not of limitation. The print medium 73 is preferably made from a pressure sensitive label construction approximately 7 to 15 mil thick, such as that available from Fasson. A specific type of label print medium is a 8 and ½ inch by 11 inch print medium cut or slit from Fasson® CopyCode™ II White Polyester/S730/50# SCK. The material is sold from Fasson in a roll form and then converted into print mediums for feeding through desktop printers by cutting or slitting the roll into 8 and ½ inch by 11 inch print mediums and forming a line of weakening by die cutting the die cut lines 72 forming the two equal primary printable areas 71. Both primary printable areas are of the dimensions 4 inches by 6 inches. When a larger than 8 and ½ inch by 11 inch image is to be printed and assembled from individual 8 and ½ by 11 inch print mediums,

The image creating application program 18 is appropriately encoded on the memory 20 and adapted to operate in conjunction with the operating system program 22 to receive control information from user input into the personal computer system 2. In response to this, the image creating application divides the larger image shown in FIG. 18 into appropriately sized sections 76. The application then causes actuation of the printer to print the graphical image on the print medium 73 such that the appropriate sections of the graphical image for that portion of the larger image which is printed on the 8.5×11 print medium is printed up to at least part of the die cut line of the printable area of the print medium 73 as shown in FIG. 19. The primary printed sections of the printed media are then removed and assembled into a larger printe assembly as shown in FIG. 20. The line 74 shown in FIG. 20 shows sections of the larger image aligned in juxtaposition to each other giving the appearance of a single large image.

Other modifications can be made to pre-existing software (e.g., enhanced graphics); however, such improvements or modifications are not specific to the present invention.

Method

The present invention also provides a method of making a finished printed output having a section of a larger graphical image printed to finished printed outputs for later assembly into a larger assembled image. This method comprises loading at least two of the substrates 14 into a desktop printer, preferably an ink jet or laser printer, connected in the personal computer system 2. The print medium 14 is loaded so that it is in a print position.

The method further comprises printing, with the desktop printer of the personal computer system 2, a section of a graphical image onto the primary printable area 16 of the print medium. The result of this is illustrated in FIG. 4, for example.

The method further comprises removing the print medium 14 from the printer 12 and removing the primary printable section 16 by pulling along the lines of weakening formed by the die cut line 12 such that the remaining portion of the print medium 16 becomes the finished printed output having at least a portion of the graphical image. This is illustrated in FIG. 4 where the printed portion 21 is printed within the primary printable area 16 and up to the die cut line 12. The primary printed sections 16 are then assembled into the image assembly illustrated in FIG. 6.

Kit

The present invention also provides a kit for making a sign assembly assembled from printed print mediums printed on by a personal desktop printer. Said kit containing a plurality label sheets for printing on by a personal desktop printer and a substrate of dimensions greater than 8.5 by 11 inches for applying a plurality of printed labels upon. A specific type of kit contains: 35 individual white polyester label sheets as show in FIG. 2 and a white vinyl substrate with dimensions of 36 inches by 72 inches. Said vinyl substrate preferably containing eyelets riveted to the corners for hanging the assembled sign assembly.

Thus, the present invention is well adapted to carry out the objects and attain the ends and advantages mentioned above as well as those inherent therein. While preferred embodiments of the invention have been described for the purpose of this disclosure, changes in the construction and arrangement of parts and the performance of steps can be made by those skilled in the art, which changes are encompassed within the spirit of this invention as defined by the appended claims.

I claim:

1. A sign assembly consisting of a plurality of printed label sheets adhered on a substrate.

2. The improvement of claim 1, wherein said printed label sheets include assembly instructions for adhering the printed label sheets to the substrate.

3. The improvement of claim 1, wherein the label sheet is transparent.

4. The improvement of claim 1, wherein the substrate is a 36 inch by 72 inch vinyl banner.

5. The improvement of claim 1, wherein the label sheets contain a line of weakening defining a primary printable area.

6. The line of weakening of claim 5, wherein said line of weakening is a die cut line.

7. The line of weakening of claim 5, wherein said line of weakening defines the sign assembly shape.

8. A method of producing an image assembly comprising the steps of:
providing a plurality of labels and a substrate;
passing the plurality printable print mediums through a printer and thereby printing sections of the image on the plurality of print mediums;
arranging said printed print mediums on said substrate;
adhering said printed print mediums on said substrate; and
wherein the printed sections when assembled correctly form an image assembly.

9. A plurality of print mediums for passing through a printer or copier for assembly into a image, comprising:
label sheets;
a line of weakening extending inward from the periphery of the label sheets;
said label sheets to be passed through a printer or copier and desired image section printed on said label sheets, which can then be separated from the label sheet said line of weakening; and
wherein, said plurality of printed label sheets are later assembled into a larger print assembly.

10. A kit consisting of a plurality of label sheets and a flexible substrate for adhering a plurality of label sheets onto.
